(19) United States
(12) Patent Application Publication
(10) Pub. No.: US 2025/0358707 A1
(43) Pub. Date: Nov. 20, 2025

(54) EXECUTION CONDITIONS FOR MULTIPLE TYPES OF CONDITIONAL MOBILITY

(71) Applicant: LG ELECTRONICS INC., Seoul (KR)

(72) Inventors: Sangwon KIM, Seoul (KR); Sunghoon JUNG, Seoul (KR); Hongsuk KIM, Seoul (KR)

(73) Assignee: LG ELECTRONICS INC., Seoul (KR)

(21) Appl. No.: 18/871,463

(22) PCT Filed: Jun. 20, 2023
(86) PCT No.: PCT/KR2023/008501

§ 371 Date: Dec. 3, 2024

Related U.S. Application Data
(60) Provisional application No. 63/354,241, filed on Jun. 22, 2022.

(51) Int. Cl. H04W 36/36; H04W 36/00

(52) U.S. Cl. CPC H04W 36/362; H04W 36/0069; H04W 36/0083

(57) ABSTRACT

A method and apparatus for execution conditions for multiple types of conditional mobility is provided. A wireless device receives a conditional configuration for a target cell from a network. The conditional configuration includes configuration parameters for the target cell, and the configuration parameters include i) a configuration of the target cell, ii) a first execution condition for Conditional Primary Secondary Cell (PSCell) Addition (CPA) and iii) a second execution condition for Conditional PSCell Change (CPC). A wireless device selects one execution condition from the first execution condition and the second execution condition based on whether a PSCell is configured or not, and applies the configuration of the target cell which fulfils the one execution condition.

### CROSS-REFERENCE TO RELATED APPLICATION(S)

This application is the National Stage filing under 35 U.S.C. 371 of International Application No. PCT/KR2023/008501, filed on Jun. 20, 2023, which claims the benefit of U.S. Provisional Application No. 63/354,241, filed on Jun. 22, 2022, the contents of which are all incorporated by reference herein in their entirety.

### TECHNICAL FIELD

The present disclosure relates to execution conditions for multiple types of conditional mobility.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

Conditional Handover (CHO) is a new solution that aims to improve the mobility robustness of a mobile terminal. In CHO, instead of preparing one target cell as in the legacy case, multiple candidate target cells are prepared in advance in the network, which enables the handover command to be sent to the mobile terminal earlier than at normal handover when the radio conditions are still good, rather than when conditions start to get degraded as in legacy handover.

The concept of CHO may be applied to Conditional Primary Secondary Cell (PSCell) Addition (CPA) and/or Conditional PSCell Change (CPC).

### SUMMARY

In an aspect, a method performed by a wireless device adapted to operate in a wireless communication system is provided. The method comprises receiving a conditional configuration for a target cell from a network. The conditional configuration includes configuration parameters for the target cell, and the configuration parameters include i) a configuration of the target cell, ii) a first execution condition for Conditional Primary Secondary Cell (PSCell) Addition (CPA) and iii) a second execution condition for Conditional PSCell Change (CPC). The method comprises selecting one execution condition from the first execution condition and the second execution condition based on whether a PSCell is configured or not, and applying the configuration of the target cell which fulfils the one execution condition.

In another aspect, an apparatus for implementing the above method is provided.

The present disclosure may have various advantageous effects.

For example, the UE can use the CPA configuration for CPC after PSCell addition, so the network signaling required for CPC configuration can be reduced.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of UE to which implementations of the present disclosure are applied.

FIGS. 4 and 5 show an example of protocol stacks in a 3GPP based wireless communication system to which implementations of the present disclosure are applied.

FIG. 6 shows a frame structure in a 3GPP based wireless communication system to which implementations of the present disclosure are applied.

FIG. 7 shows a data flow example in the 3GPP NR system to which implementations of the present disclosure are applied.

FIG. 8 shows an example of a CPA procedure to which implementations of the present disclosure are applied.

FIG. 9 shows an example of a method performed by a wireless device to which implementations of the present disclosure are applied.

FIG. 10 shows an example of a method performed by a base station to which implementations of the present disclosure are applied.

FIG. 11 shows an example of UE operation to which implementations of the present disclosure are applied.

FIG. 12 shows an example of a procedure to which implementations of the present disclosure are applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in Downlink (DL) and SC-FDMA in Uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

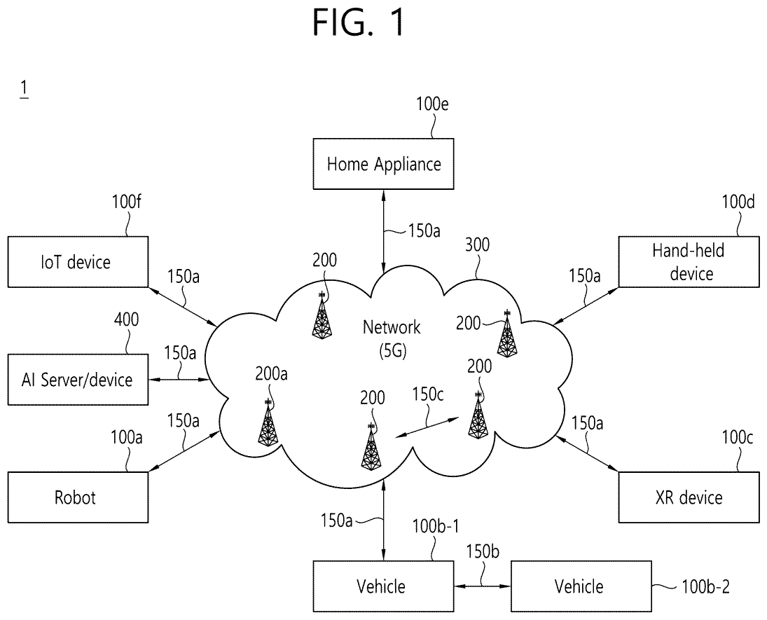

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

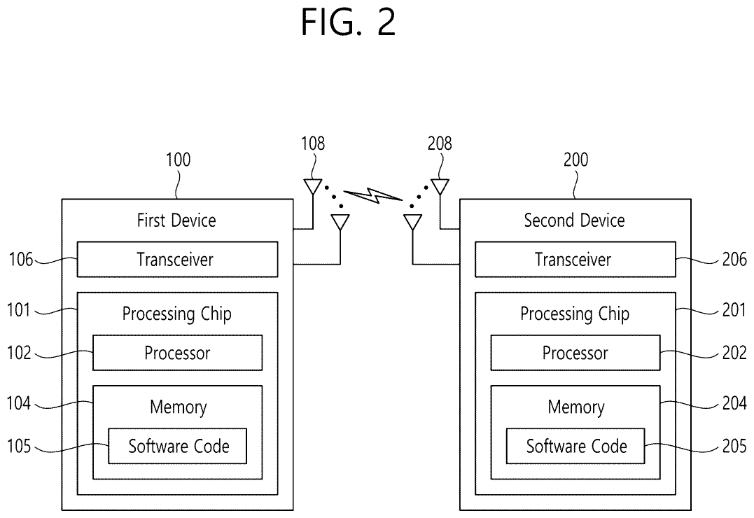

FIG. 2 shows an example of wireless devices to which implementations of the present disclosure are applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

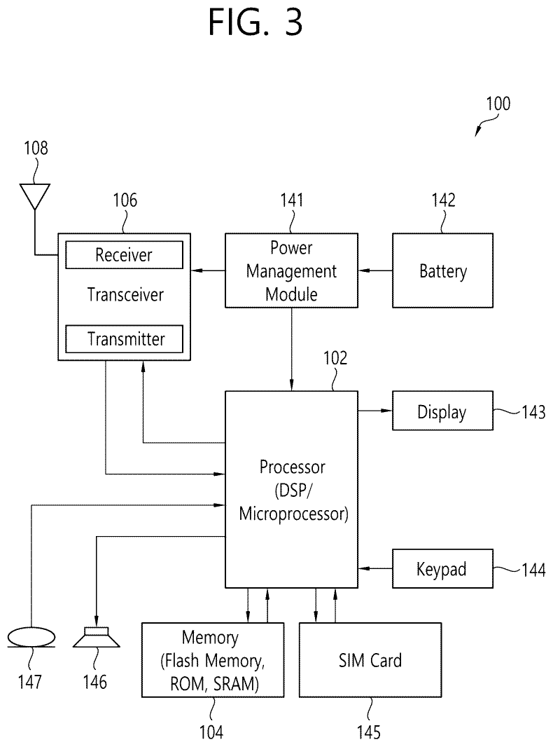

FIG. 3 shows an example of UE to which implementations of the present disclosure are applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

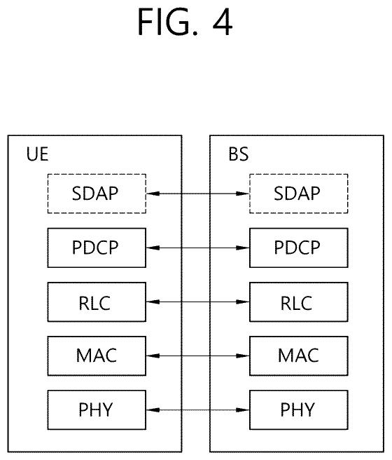

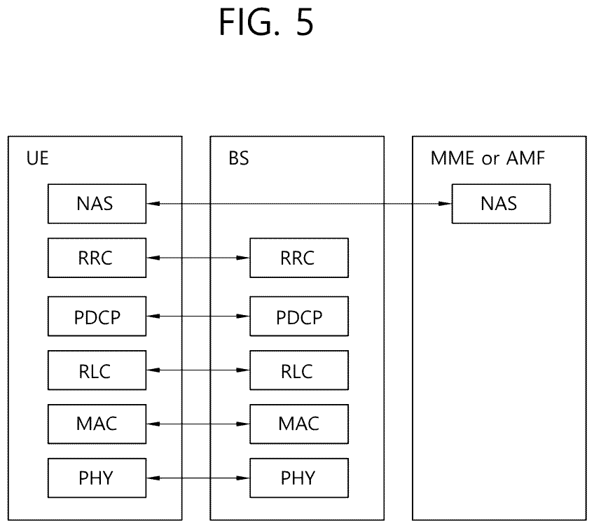

FIGS. 4 and 5 show an example of protocol stacks in a 3GPP based wireless communication system to which implementations of the present disclosure are applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QOS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

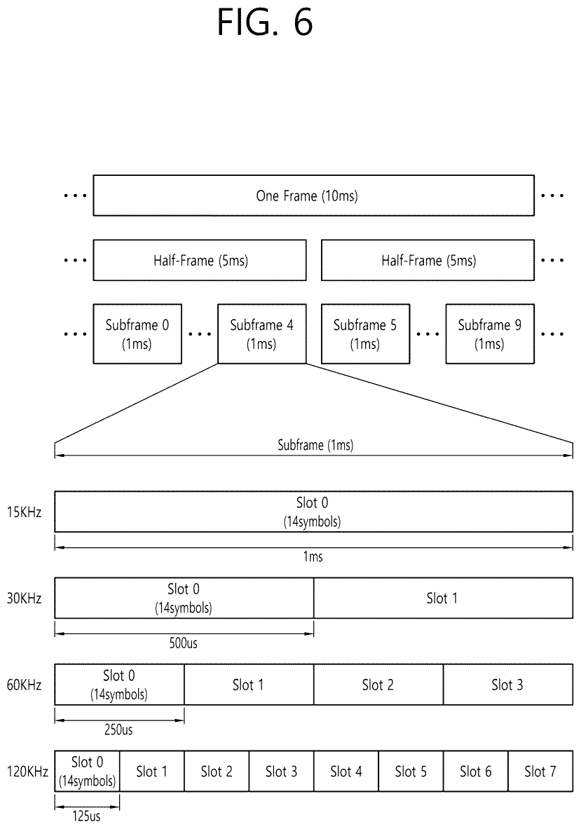

FIG. 6 shows a frame structure in a 3GPP based wireless communication system to which implementations of the present disclosure are applied.

The frame structure shown in FIG. 6 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is Ims. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{μ}*15 KHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*/N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL Component Carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell (SpCell). The configured set of serving cells for a UE therefore always consists of one PCell and one or more SCells. For Dual Connectivity (DC) operation, the term SpCell refers to the PCell of the Master Cell Group (MCG) or the Primary SCell (PSCell) of the Secondary Cell Group (SCG). An SpCell supports Physical Uplink Control Channel (PUCCH) transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

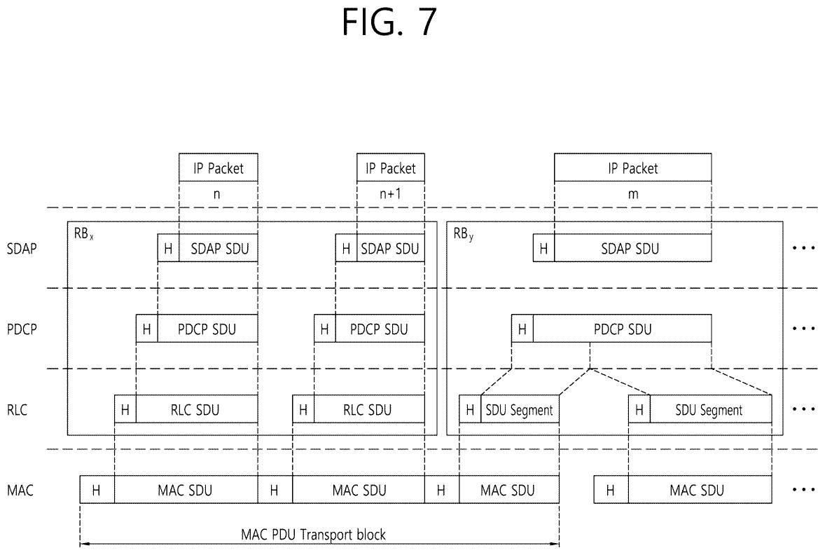

FIG. 7 shows a data flow example in the 3GPP NR system to which implementations of the present disclosure are applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

A Conditional PSCell Addition (CPA) is described.

The Secondary Node (SN) Addition procedure is initiated by the Master Node (MN) and is used to establish a UE context at the SN in order to provide resources from the SN to the UE. For bearers requiring SCG radio resources, this procedure is used to add at least the initial SCG serving cell of the SCG. This procedure can also be used to configure an SN terminated MCG bearer (where no SCG configuration is needed). In case of CPA, this procedure can be used for CPA configuration and CPA execution.

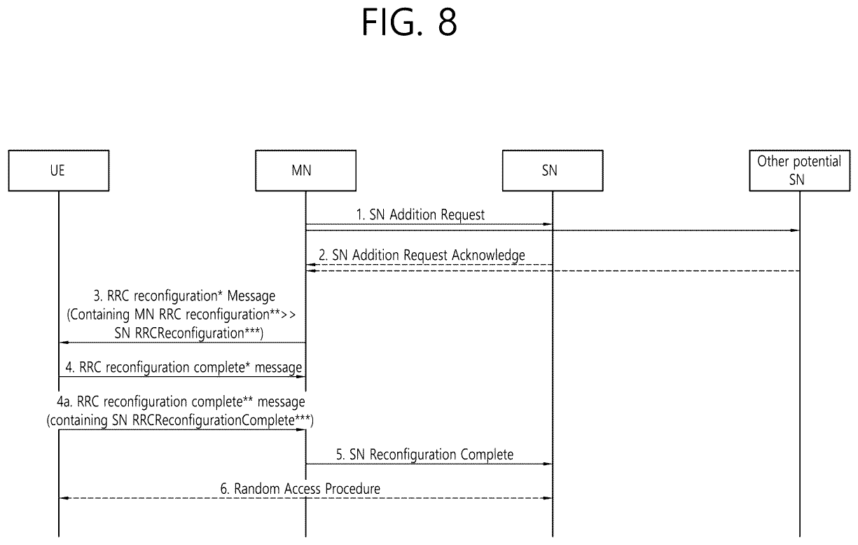

FIG. 8 shows an example of a CPA procedure to which implementations of the present disclosure are applied.

1. The MN decides to configure CPA for the UE. The MN requests the target candidate SN to allocate resources for one or more specific PDU sessions/QoS Flows, indicating QoS Flows characteristics (QOS Flow Level QoS parameters, PDU session level Transport Network Layer (TNL) address information, and PDU session level network slice information), provides the upper limit for the number of PSCells to the candidate SN. In addition, for bearers requiring SCG radio resources, the MN indicates the requested SCG configuration information, including the entire UE capabilities and the UE capability coordination result. In this case, the MN also provides the candidate cells recommended by MN via the latest measurement results for the SN to choose and configure the SCG cell(s). The MN may request the SN to allocate radio resources for split SRB operation. In NR-DC, the MN always provides all the needed security information to the SN (even if no SN terminated bearers are setup) to enable SRB3 to be setup based on SN decision.

2. If the Radio Resource Management (RRM) entity in the SN is able to admit the resource request, it allocates respective radio resources and, dependent on the bearer type options, respective transport network resources, and provides the prepared PSCell ID(s) to the MN. For bearers requiring SCG radio resources, the SN triggers UE random access so that synchronization of the SN radio resource configuration can be performed. Within the list of cells as indicated within the measurement results indicated by the MN, the SN decides the list of PSCell(s) to prepare and, for each prepared PSCell, the SN decides other SCG SCells and provides the new corresponding SCG radio resource configuration to the MN in an NR RRC configuration message (RRCReconfiguration***), contained in the SN Addition Request Acknowledge message. The target SN can either accept or reject each of the candidate cells suggested by the MN, i.e., it cannot come up with any alternative candidates.

3. The MN transmits to the UE an RRC reconfiguration message (RRCReconfiguration*) including the CPA configuration (i.e., a list of RRC reconfiguration** messages) and associated execution conditions, in which an RRC reconfiguration** message contains a RRCReconfiguration*** received from the candidate SN and possibly an MCG configuration. Besides, the RRC reconfiguration message (RRC reconfiguration*) can also include the current MCG updated configuration. e.g. to configure the required conditional measurements.

4. The UE applies the RRC configuration (in the RRCReconfiguration*) excluding the CPA configuration, stores the CPA configuration and replies to the MN with an RRC reconfiguration complete message (RRCReconfigurationComplete*) without any NR SN RRC response message). In case the UE is unable to comply with (part of) the configuration included in the RRC reconfiguration* message, it performs the reconfiguration failure procedure.

4a. The UE starts evaluating the execution conditions. If the execution condition of one candidate PSCell is satisfied, the UE applies RRC reconfiguration message (RRCReconfiguration**) corresponding to the selected candidate PSCell, and transmits an MN RRC reconfiguration complete message (RRCReconfigurationComplete**), including an NR RRC reconfiguration complete message (RRCReconfigurationComplete***) for the selected candidate PSCell, and the selected PSCell information to the MN.

5. The MN informs the SN that the UE has completed the reconfiguration procedure successfully via SN Reconfiguration Complete message, including the RRCReconfigurationComplete*** message. The MN transmits the SN Release Request message(s) to cancels CPA in the other target candidate SN(s), if configured.

6. The UE performs synchronization towards the selected PSCell indicated in the RRC reconfiguration** message. The order the UE transmits the MN RRC reconfiguration complete** message and performs the random access procedure towards the SCG is not defined. The successful RA procedure towards the SCG is not required for a successful completion of the RRC connection reconfiguration procedure.

A Conditional PSCell Change (CPC) is described.

CPC is defined as a PSCell change that is executed by the UE when execution condition(s) is met. The UE starts evaluating the execution condition(s) upon receiving the CPC configuration, and stops evaluating the execution condition(s) once PSCell change is triggered. Intra-SN CPC without MN involvement, inter-SN CPC initiated either by MN or SN are supported.

The following principles apply to CPC.
The CPC configuration contains the configuration of CPC candidate PSCell(s) and execution condition(s) and may contain the MN configuration for inter-SN CPC.
An execution condition may consist of one or two trigger condition(s) (CPC events A3/A5). Only single Reference Signal (RS) type is supported and at most two different trigger quantities (e.g., Reference Signal Received Power (RSRP) and Reference Signal Received Quality (RSRQ), RSRP and Signal-to-Noise plus Interference Ratio (SINR), etc.) can be configured simultaneously for the evolution of CPC execution condition of a single candidate PSCell.
Before any CPC execution condition is satisfied, upon reception of PSCell change command or PCell change command, the UE executes the PSCell change procedure or the PCell change procedure, regardless of any previously received CPC configuration. Upon the successful completion of PSCell change procedure or PCell change procedure, the UE releases all stored CPC configurations.
While executing CPC, the UE is not required to continue evaluating the execution condition of other candidate PSCell(s).
Once the CPC procedure is executed successfully, the UE releases all stored CPC configurations.
Upon the release of SCG, the UE releases the stored CPC configurations.

CPC configuration in Handover (HO) command, PSCell change command or conditional reconfiguration is not supported.

Even though a UE is configured with CPA for more than one neighbor cells, once one of the neighbor cells is added as a PSCell, the CPA configurations for other neighbor cells may be no longer useful. If the target cell is same, it is expected that the CPA configuration and CPC configuration are almost same, except execution condition. Nevertheless, for PSCell change, the network may need to separately configure CPC for the same neighbor cells after the PSCell addition.

According to implementations of the present disclosure, the UE may select a set of execution conditions between two sets of execution conditions configured for a conditional mobility, based on whether the UE is configured with a PSCell or not. The first set of execution conditions may be used to decide whether to execute the PSCell addition, and the second set of execution conditions may be used to decide whether to execute the PSCell change. The UE may execute the conditional mobility when the execution conditions which belong to the selected set is met.

More specifically, to reuse the CPA configuration for CPC after PSCell addition, the execution condition for CPA and CPC may be configured together in a conditional reconfiguration. For example, the execution condition for CPA and CPC may be configured together in CondReconfigToAddMod. Then, such conditional reconfiguration may be used after SN release for CPA again.

Since the CPC cannot be executed while SCG is not configured, if the execution condition for CPA and CPC are configured together in a conditional reconfiguration, the UE may evaluate only CPA execution condition while SCG is not configured. Meanwhile, the UE may evaluate only CPC execution condition if SCG has been configured.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

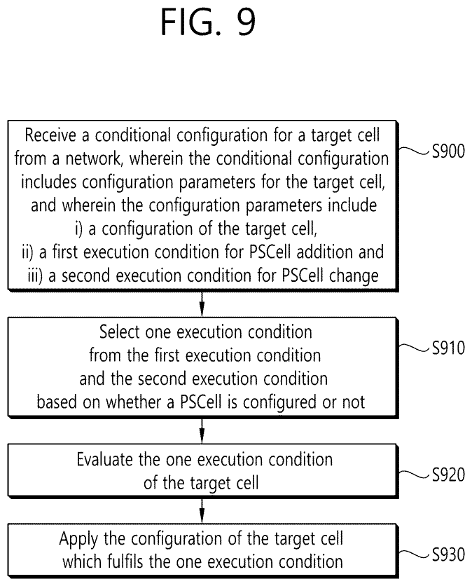

FIG. 9 shows an example of a method performed by a wireless device to which implementations of the present disclosure are applied.

In step S900, the method comprises receiving a conditional configuration for a target cell from a network. The conditional configuration includes configuration parameters for the target cell. The configuration parameters include i) a configuration of the target cell, ii) a first execution condition for CPA and iii) a second execution condition for CPC.

In step S910, the method comprises selecting one execution condition from the first execution condition and the second execution condition based on whether a PSCell is configured or not.

In step S920, the method comprises evaluating the one execution condition of the target cell.

In step S930, the method comprises applying the configuration of the target cell which fulfils the one execution condition.

In some implementations, the first execution condition may be selected for the one execution condition based on the PSCell not being configured. In other words, when the PSCell is not configured, the first execution condition may be selected for the one execution condition. For example, evaluating the one execution condition of the target cell may comprise determining whether to execute the CPA based on the first execution condition selected for the one execution condition. For example, applying the configuration of the target cell may comprise executing the CPA with the target cell which fulfils the first execution condition. For example, the first execution condition may be considered valid, and the second execution condition may be considered invalid. For example, the first execution condition selected for the one execution condition may be only evaluated, and the second execution condition not selected for the one execution condition may not be evaluated.

In some implementations, the second execution condition may be selected for the one execution condition based on the PSCell being configured. In other words, when the PSCell is configured, the second execution condition may be selected for the one execution condition. For example, evaluating the one execution condition of the target cell may comprise determining whether to execute the CPC based on the second execution condition selected for the one execution condition. For example, applying the configuration of the target cell may comprise executing the CPC with the target cell which fulfils the second execution condition. For example, the second execution condition may be considered valid, and the first execution condition may be considered invalid. For example, the second execution condition selected for the one execution condition may be only evaluated, and the first execution condition not selected for the one execution condition may not be evaluated.

In some implementations, the first execution condition may comprise at least one of CondEvent A4 or CondEvent B1.

In some implementations, the second execution condition may comprise at least one of CondEvent A3 or CondEvent A5.

In some implementations, the first execution condition may belong to a first set of execution conditions.

In some implementations, the second execution condition may belong to a second set of execution conditions.

In some implementations, the wireless device may be connected to both a Master Node (MN) and a Secondary Node (SN) in a Dual Connectivity (DC). A Master Cell Group (MCG) comprising a Primary Cell (PCell) and optionally one or more SCells may be associated with the MN. A Secondary Cell Group (SCG) comprising the PSCell and optionally one or more SCells may be with the SN.

In some implementations, the wireless device may be in communication with at least one of a mobile device, a network, and/or autonomous vehicles other than the wireless device.

Furthermore, the method in perspective of the wireless device described above in FIG. 9 may be performed by the first wireless device 100 shown in FIG. 2 and/or the UE 100 shown in FIG. 3.

The wireless device comprises at least one transceiver, at least one processor, and at least one memory operably connectable to the at least one processor and storing instructions that, based on being executed by the at least one processor, perform the method described in FIG. 9.

More specifically, the wireless device receives a conditional configuration for a target cell from a network. The conditional configuration includes configuration parameters for the target cell. The configuration parameters include i) a configuration of the target cell, ii) a first execution condition for CPA and iii) a second execution condition for CPC.

The wireless device selects one execution condition from the first execution condition and the second execution condition based on whether a PSCell is configured or not.

The wireless device evaluates the one execution condition of the target cell.

The wireless device applies the configuration of the target cell which fulfils the one execution condition.

In some implementations, the first execution condition may be selected for the one execution condition based on the PSCell not being configured. In other words, when the PSCell is not configured, the first execution condition may be selected for the one execution condition. For example, evaluating the one execution condition of the target cell may comprise determining whether to execute the CPA based on the first execution condition selected for the one execution condition. For example, applying the configuration of the target cell may comprise executing the CPA with the target cell which fulfils the first execution condition. For example, the first execution condition may be considered valid, and the second execution condition may be considered invalid. For example, the first execution condition selected for the one execution condition may be only evaluated, and the second execution condition not selected for the one execution condition may not be evaluated.

In some implementations, the second execution condition may be selected for the one execution condition based on the PSCell being configured. In other words, when the PSCell is configured, the second execution condition may be selected for the one execution condition. For example, evaluating the one execution condition of the target cell may comprise determining whether to execute the CPC based on the second execution condition selected for the one execution condition. For example, applying the configuration of the target cell may comprise executing the CPC with the target cell which fulfils the second execution condition. For example, the second execution condition may be considered valid, and the first execution condition may be considered invalid. For example, the second execution condition selected for the one execution condition may be only evaluated, and the first execution condition not selected for the one execution condition may not be evaluated.

In some implementations, the first execution condition may comprise at least one of CondEvent A4 or CondEvent B1.

In some implementations, the second execution condition may comprise at least one of CondEvent A3 or CondEvent A5.

In some implementations, the first execution condition may belong to a first set of execution conditions.

In some implementations, the second execution condition may belong to a second set of execution conditions.

In some implementations, the wireless device may be connected to both an MN and an SN in a DC. An MCG comprising a PCell and optionally one or more SCells may be associated with the MN. An SCG comprising the PSCell and optionally one or more SCells may be with the SN.

Furthermore, the method in perspective of the wireless device described above in FIG. 9 may be performed by control of the processor 102 included in the first wireless device 100 shown in FIG. 2 and/or by control of the processor 102 included in the UE 100 shown in FIG. 3.

A processing apparatus adapted to control a wireless device comprises at least one processor, and at least one memory operably connectable to the at least one processor. The at least one processor is adapted to perform the method described in FIG. 9.

Furthermore, the method in perspective of the wireless device described above in FIG. 9 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as Synchronous DRAM (SDRAM), ROM, Non-Volatile RAM (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory Computer-Readable Medium (CRM) stores instructions that, based on being executed by at least one processor, perform the method described in FIG. 9.

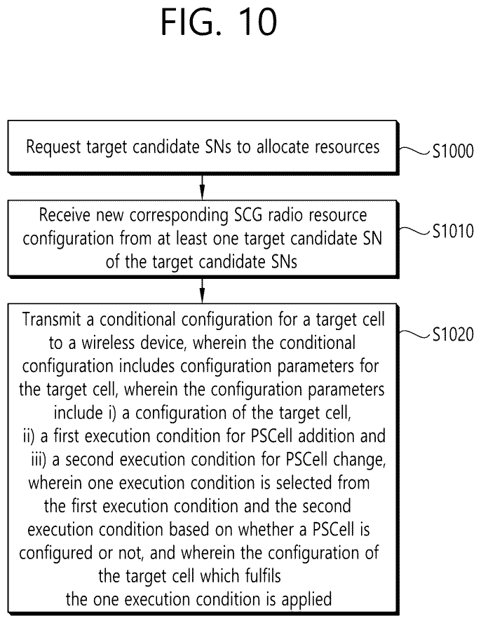

FIG. 10 shows an example of a method performed by a base station to which implementations of the present disclosure are applied.

In step S1000, the method comprises requesting target candidate SNs to allocate resources.

In step S1010, the method comprises receiving new corresponding SCG radio resource configuration from at least one target candidate SN of the target candidate SNs.

In step S1020, the method comprises transmitting a conditional configuration for a target cell to a wireless device. The conditional configuration includes configuration parameters for the target cell. The configuration parameters include i) a configuration of the target cell, ii) a first execution condition for CPA and iii) a second execution condition for CPC.

One execution condition is selected from the first execution condition and the second execution condition based on whether a PSCell is configured or not. The configuration of the target cell which fulfils the one execution condition is applied.

In some implementations, the first execution condition may be selected for the one execution condition based on the PSCell not being configured. In other words, when the PSCell is not configured, the first execution condition may be selected for the one execution condition.

In some implementations, the second execution condition may be selected for the one execution condition based on the PSCell being configured. In other words, when the PSCell is configured, the second execution condition may be selected for the one execution condition.

In some implementations, the first execution condition may comprise at least one of CondEvent A4 or CondEvent B1.

In some implementations, the second execution condition may comprise at least one of CondEvent A3 or CondEvent A5.

In some implementations, the base station may be an MN in a DC.

Furthermore, the method in perspective of the base station described above in FIG. 10 may be performed by the second wireless device 200 shown in FIG. 2.

The base station comprises at least one transceiver, at least one processor, and at least one memory operably connectable to the at least one processor and storing instructions that, based on being executed by the at least one processor, perform the method described in FIG. 10.

More specifically, the base station requests target candidate SNs to allocate resources.

The base station receives new corresponding SCG radio resource configuration from at least one target candidate SN of the target candidate SNs.

The base station transmits a conditional configuration for a target cell to a wireless device. The conditional configuration includes configuration parameters for the target cell. The configuration parameters include i) a configuration of the target cell, ii) a first execution condition for CPA and iii) a second execution condition for CPC.

One execution condition is selected from the first execution condition and the second execution condition based on whether a PSCell is configured or not. The configuration of the target cell which fulfils the one execution condition is applied.

In some implementations, the first execution condition may be selected for the one execution condition based on the PSCell not being configured. In other words, when the PSCell is not configured, the first execution condition may be selected for the one execution condition.

In some implementations, the second execution condition may be selected for the one execution condition based on the PSCell being configured. In other words, when the PSCell is configured, the second execution condition may be selected for the one execution condition.

In some implementations, the first execution condition may comprise at least one of CondEvent A4 or CondEvent B1.

In some implementations, the second execution condition may comprise at least one of CondEvent A3 or CondEvent A5.

In some implementations, the base station may be an MN in a DC.

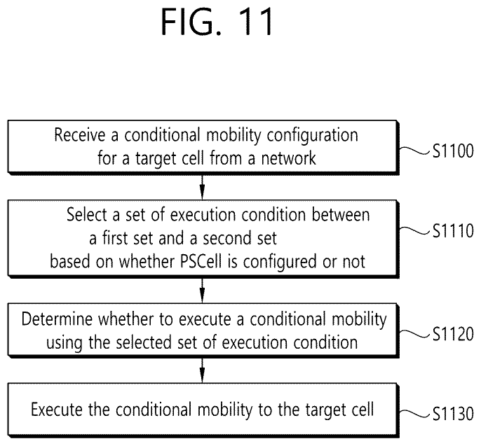

FIG. 11 shows an example of UE operation to which implementations of the present disclosure are applied.

In step S1100, the UE receives a conditional mobility configuration for a target cell from a network.

For example, the conditional mobility configuration may include at least one of: configuration parameters for the target cell, at least one first execution condition, and at least one second execution condition.

For example, a set of execution conditions may comprise one or more one execution conditions. The at least one first execution condition may belong to a first set of execution conditions. The at least one second execution condition may belong to a second set of execution conditions.

For example, each execution condition configured in the conditional mobility configuration may belong to either the first set of execution conditions or the second set of execution conditions.

For example, the execution condition which belongs to the first set of execution conditions may be used to evaluate the target cell indicated in the conditional mobility configuration for CPA. That is, the execution condition which belongs to the first set of execution conditions may be used to determine whether to execute CPA using the target cell indicated in the conditional mobility configuration.

For example, the execution condition which belongs to the second set of execution conditions may be used to evaluate the target cell indicated in the conditional mobility configuration for CPC. That is, the execution condition which belongs to the second set of execution conditions may be used to determine whether to execute CPC using the target cell indicated in the conditional mobility configuration.

For example, the execution condition which belongs to the first set of execution conditions may be CondEvent A4 or CondEvent B1. The execution condition which belongs to the second set of execution conditions may be CondEvent A3 or CondEvent A5.

For example, CondEvent A3 means that Conditional reconfiguration candidate becomes amount of offset better than PCell/PSCell. CondEvent A4 means that conditional reconfiguration candidate becomes better than absolute threshold. CondEvent A5 means that PCell/PSCell becomes worse than absolute threshold1 and conditional reconfiguration candidate becomes better than another absolute threshold2.

For example, the network configures the UE with one or more candidate target Special Cells (SpCells) in the conditional reconfiguration. The network provides the configuration parameters for the target SpCell in the ConditionalReconfiguration IE.

If the ConditionalReconfiguration contains the condReconfigToAddModList, the UE performs conditional reconfiguration addition/modification.

For each condReconfigId received in the condReconfigToAddModList IE, the UE may:
1> if an entry with the matching condReconfigId exists in the condReconfigToAddModList within the VarConditionalReconfig:
2> if the entry in condReconfigToAddModList includes an condExecutionCond or condExecutionCondSCG;
3> replace condExecutionCond or condExecutionCondSCG within the VarConditionalReconfig with the value received for this condReconfigId;
2> if the entry in condReconfigToAddModList includes an condRRCReconfig;
3> replace condRRCReconfig within the VarConditionalReconfig with the value received for this condReconfigId;
1> else:
2> add a new entry for this condReconfigId within the VarConditionalReconfig;

In step S1110, the UE selects a set of execution condition between the first set of execution conditions and the second set of execution conditions based on whether PSCell is configured or not.

For example, if a set of execution conditions for CPA and another set of execution conditions for CPC are configured in the conditional mobility configuration, the UE may select a set of execution condition based on whether PSCell is configured or not. For example, if the UE is not configured with a PSCell, the UE may select the execution condition for CPA. For example, if the UE is configured with a PSCell, the UE may select the execution conditions for CPC.

For example, the UE may consider the selected set of execution conditions as valid, and consider the set of execution conditions which is not selected as invalid. For example, if the UE is not configured with a PSCell, the UE may consider the execution condition for CPA as valid but the execution condition for CPC as invalid. For example, if the UE is configured with a PSCell, the UE may consider the execution condition for CPC as valid but the execution condition for CPA as invalid.

Alternatively, if the execution condition for CPA and the execution condition for CPC are configured in the conditional mobility configuration, the UE may consider only the execution condition for CPA as valid. The UE may discard the execution condition for CPA and keep other configuration except the execution condition for CPA after PSCell is added.

Alternatively, for a conditional mobility, if the execution condition for CPA and the execution condition for CPC are configured, the UE may consider that the conditional mobility is for CPA, while the UE is not configured with PSCell.

Alternatively, for a conditional mobility, if the execution condition for CPA and the execution condition for CPC are configured, the UE may consider that the conditional mobility is for CPC, while the UE is configured with PSCell.

In step S1120, the UE determines whether to execute the conditional mobility using the selected set of execution condition. That is, the UE evaluates the target cell using the selected set of execution conditions.

For example, if the execution condition for CPA is selected, the UE may determine whether to execute the CPA using the execution condition for CPA. For example, if the execution condition for CPC is selected, the UE may determine whether to execute the CPC using the execution condition for CPC.

For example, the UE may evaluate the selected set of execution condition and may not evaluate the execution condition which is not selected. For example, if the execution condition for CPA is selected, the UE may evaluate the execution condition for CPA and may not evaluate the execution condition for CPC. For example, if the execution condition for CPC is selected, the UE may evaluate the execution condition for CPC and may not evaluate the execution condition for CPA.

For example, the UE may evaluate the valid execution condition only to decide whether to execute the conditional mobility.

For example, the UE may evaluate the condition of each configured candidate target SpCell. The UE may:
1> for each condReconfigId within the VarConditionalReconfig:
2> if the RRCReconfiguration within condRRCReconfig includes the masterCellGroup including the reconfigurationWithSync, consider the cell which has a physical cell identity matching the value indicated in the ServingCellConfigCommon included in the reconfiguration WithSync within the masterCellGroup in the received condRRCReconfig to be applicable cell;
2> if the RRCReconfiguration within condRRCReconfig includes the secondaryCellGroup including the reconfigurationWithSync, consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedures, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig via SRB1:
4> in the remainder of the procedures, consider each measId indicated in the condExecutionCond as a measId in the VarMeasConfig associated with the SCG measConfig;
3> otherwise:
4> in the remainder of the procedures, consider each measId indicated in the condExecutionCond as a measId in the VarMeasConfig associated with the MCG measConfig;
2> for each measId included in the measIdList within VarMeasConfig indicated in the condExecutionCond or condExecutionCondSCG associated to condReconfigId:
3> if the condEventId is associated with condEventT1, and if the entry condition(s) applicable for this event associated with the condReconfigId, i.e. the event corresponding with the condEventId(s) of the corresponding condTriggerConfig within VarConditionalReconfig, is fulfilled for the applicable cells; or
3> if the condEventId is associated with condEventD1, and if the entry condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig; or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified; or
3> if the condEventId is associated with condEventT1, and if the leaving condition(s) applicable for this event associated with the condReconfigId, i.e. the event corresponding with the condEventId(s) of the corresponding condTriggerConfig within VarConditionalReconfig, is fulfilled for the applicable cells; or
3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;

In step S1130, the UE executes the conditional mobility to the target cell.

For example, if the selected set of execution condition is met, the UE may execute the conditional mobility corresponding to the selected set of execution condition.

For example, if the execution condition for CPA is selected and met, the UE may execute the CPA. For example, if the execution condition for CPC is selected and met, the UE may execute the CPC.

For example, the UE may apply the conditional reconfiguration associated with one of the target SpCells which fulfils associated execution condition. The UE may:
1> if more than one triggered cell exists:
2> select one of the triggered cells as the selected cell for conditional reconfiguration execution;
1> else:
2> consider the triggered cell as the selected cell for conditional reconfiguration execution;
1> for the selected cell of conditional reconfiguration execution:
2> apply the stored condRRCReconfig of the selected cell;

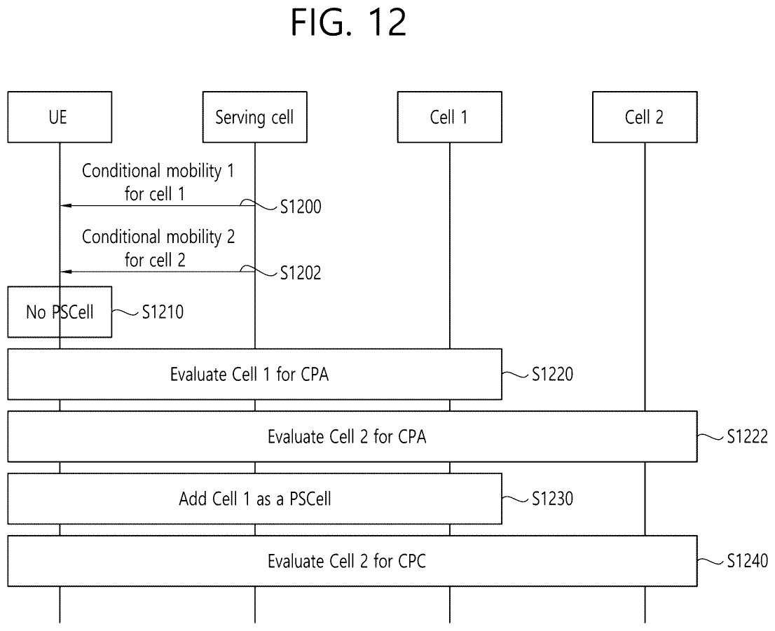

FIG. 12 shows an example of a procedure to which implementations of the present disclosure are applied.

In FIG. 12, a UE is currently not configured with PSCell and receives two conditional mobility configurations from a serving cell.

In step S1200, the UE receives a first conditional mobility configuration for cell 1.

The first conditional mobility configuration includes the execution condition for CPA and the execution condition for CPC and the mobility target cell is cell 1.

In step S1202, the UE receives a second conditional mobility configuration for cell 2. The second conditional mobility configuration includes the execution condition for CPA and the execution condition for CPC and the mobility target cell is cell 2.

In step S1210, since the UE is not configured with PSCell, the UE considers that the execution condition for CPA is only valid in both conditional mobility configurations.

In step S1220 and S1222, the UE determines whether the execution condition for CPA is met for mobility target cell, i.e., cell 1 and cell 2.

In step S1230, the execution condition for CPA indicated in the first conditional mobility configuration is met. The UE adds cell 1 as a PSCell.

In step S1240, since the UE is configured with PSCell, the UE considers that the execution condition for CPC is only valid in the second conditional mobility configurations. The UE determines whether the execution condition for CPC is met for mobility target cell, i.e., cell 2.

The present disclosure may have various advantageous effects.

For example, the UE can use the CPA configuration for CPC after PSCell addition, so the network signaling required for CPC configuration can be reduced.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving a conditional configuration for a target cell from a network,
wherein the conditional configuration includes configuration parameters for the target cell, and
wherein the configuration parameters include i) a configuration of the target cell, ii) a first execution condition for Conditional Primary Secondary Cell (PSCell) Addition (CPA) and iii) a second execution condition for Conditional PSCell Change (CPC);
selecting one execution condition from the first execution condition and the second execution condition based on whether a PSCell is configured or not;
evaluating the one execution condition of the target cell; and
applying the configuration of the target cell which fulfils the one execution condition.

2. The method of claim 1, wherein the first execution condition is selected for the one execution condition based on the PSCell not being configured.

3. The method of claim 2, wherein evaluating the one execution condition of the target cell comprises determining whether to execute the CPA based on the first execution condition selected for the one execution condition.

4. The method of claim 2, wherein applying the configuration of the target cell comprises executing the CPA with the target cell which fulfils the first execution condition.

5. The method of claim 2, wherein the first execution condition is considered valid, and the second execution condition is considered invalid.

6. The method of claim 2, wherein the first execution condition selected for the one execution condition is only evaluated, and the second execution condition not selected for the one execution condition is not evaluated.

7. The method of claim 1, wherein the second execution condition is selected for the one execution condition based on the PSCell being configured.

8. The method of claim 7, wherein evaluating the one execution condition of the target cell comprises determining whether to execute the CPC based on the second execution condition selected for the one execution condition.

9. The method of claim 7, wherein applying the configuration of the target cell comprises executing the CPC with the target cell which fulfils the second execution condition.

10. The method of claim 7, wherein the second execution condition is considered valid, and the first execution condition is considered invalid.

11. The method of claim 7, wherein the second execution condition selected for the one execution condition is only evaluated, and the first execution condition not selected for the one execution condition is not evaluated.

12. The method of claim 1, wherein the first execution condition comprises at least one of CondEvent A4 or CondEvent B1.

13. The method of claim 1, wherein the second execution condition comprises at least one of CondEvent A3 or CondEvent A5.

14. The method of claim 1, wherein the first execution condition belongs to a first set of execution conditions.

15. The method of claim 1, wherein the second execution condition belongs to a second set of execution conditions.

16. The method of claim 1, wherein the method is performed by a wireless device, and
wherein the wireless device is connected to both a Master Node (MN) and a Secondary Node (SN) in a Dual Connectivity (DC).

17. The method of claim 16, wherein a Master Cell Group (MCG) comprises a Primary Cell (PCell) and optionally one or more SCells is associated with the MN.

18. The method of claim 16, wherein a Secondary Cell Group (SCG) comprises the PSCell and optionally one or more SCells is associated with the SN.

19. (canceled)

20. A wireless device comprising:
at least one transceiver;
at least one processor; and
at least one memory operably connectable to the at least one processor and storing instructions that, based on being executed by the at least one processor, perform operations comprising:
receiving, via the at least one transceiver, a conditional configuration for a target cell from a network,
wherein the conditional configuration includes configuration parameters for the target cell, and
wherein the configuration parameters include i) a configuration of the target cell, ii) a first execution condition for Conditional Primary Secondary Cell (PSCell) Addition (CPA) and iii) a second execution condition for Conditional PSCell Change (CPC);
selecting one execution condition from the first execution condition and the second execution condition based on whether a PSCell is configured or not:
evaluating the one execution condition of the target cell; and
applying the configuration of the target cell which fulfils the one execution condition.

21-28. (canceled)

29. A base station comprising:
at least one transceiver;
at least one processor; and
at least one memory operably connectable to the at least one processor and storing instructions that, based on being executed by the at least one processor, perform operations comprising
requesting target candidate Secondary Nodes (SNs) to allocate resources;
receiving, via the at least one transceiver, new corresponding Secondary Cell Group (SCG) radio resource configuration from at least one target candidate SN of the target candidate SNs; and
transmitting, via the at least one transceiver, a conditional configuration for a target cell to a wireless device,
wherein the conditional configuration includes configuration parameters for the target cell,
wherein the configuration parameters include i) a configuration of the target cell, ii) a first execution condition for Conditional Primary Secondary Cell (PSCell) Addition (CPA) and iii) a second execution condition for Conditional PSCell Change (CPC),
wherein one execution condition is selected from the first execution condition and the second execution condition based on whether a PSCell is configured or not, and
wherein the configuration of the target cell which fulfils the one execution condition is applied.
